(19) United States
(12) Patent Application Publication
(10) Pub. No.: US 2005/0235537 A1
(43) Pub. Date: Oct. 27, 2005

(54) Display unit

(76) Inventors: Arthur Robert Lee, Nuneaton (GB); Christopher James Thomas Drake, Leicester (GB)

Correspondence Address: King & Jovanovic, Suite 230, 170 College Avenue, Holland, MI, 49423, US

(21) Appl. No.: 10/518,066

(22) PCT Filed: Jun. 13, 2003
(86) PCT No.: PCT/GB03/02541

§ 371 Date: Dec. 13, 2004

(30) Foreign Application Priority Data
Jun. 13, 2002 (GB) 0213570.5

(51) Int. Cl. G09F 15/00

(52) U.S. Cl. 40/607.03

(57) ABSTRACT

A display unit (1) for mounting on a post (2) is described, the display unit (1) comprising a mount (21) mountable on the post (2) and a display carrier (41) for displaying aposterora sign. The display carrier (41) is movably coupled to the mount (21) and, in use, the display carrier (41) is located in a first position for displaying the poster or sign, and can be moved to a second position, lower than the first position, for changing the poster or sign.

The present invention relates to a display unit having means to increase the ease with which the material displayed therein, for example advertisements, may be replaced. More particularly, the present invention relates to a display unit for mounting on a vertical structure, such as an erected post, lamppost or other similar vertical structure.

Advertising or promotional signs are often displayed on specially adapted stands normally located outside shops or on garage forecourts. It is also known to mount display frames on lamp posts or similar structures. The display frame is fixed so that the sign is aligned to be seen by the public and mounted at a height to be visually effective from a distance.

It is often desirable to mount advertising displays in an elevated position in order to increase their visibility, particularly when a display is to be viewed from a distance. This usually requires that the displays are mounted at a height such that they may not be reached from ground level. To facilitate access to the posters, for example to change the advertising display, it is hence necessary to employ a ladder or hydraulic lift. The use of a ladder or hydraulic lift increases the degree of risk to a person changing the advertising display and increases the cost associated with changing the display.

There is therefore a requirement for a display unit enabling access to the advertising or other material being displayed without requiring additional means to elevate the person to the level of the display unit.

Viewed from a first aspect the present invention provides a display unit for mounting on a post, the display unit comprising a mount mountable on the post and a display carrier for displaying a poster or a sign, the display carrier being movably coupled to the mount, wherein, in use, the display carrier is locatable in a first position for displaying the poster or sign, and is movable to a second position, lower than the first position, for changing the poster or sign.

Thus, the poster or sign may be changed by lowering the display carrier relative to the mount. Preferably, the second position is at or proximal to ground level so that the poster or sign may be changed without the need for a ladder or lifting apparatus. The post is preferably a lamppost.

The display unit is preferably provided with a display surface for displaying the poster or sign. The display surface may be provided behind the poster or sign to provide support. Alternatively, the display surface may be at least partially transparent and located in front of the sign or poster. The sign or poster is preferably removably attached to the display surface. The display surface is preferably defined by a sheet element, although it may equally be defined by a frame member or frame assembly. If the display surface is defined by a sheet element, the sheet element is preferably at least partially transparent. The display surface is preferably substantially the same size and/or shape as the poster or sign.

Preferably, the display carrier is suspended from the mount.

Advantageously, the display carrier may be located substantially within the mount, when located in said first position. Thus, the display carrier is protected when it is in said first position. Preferably, the mount is provided with an aperture through which the sign or poster may be viewed when the display carrier is in said first position. A transparent member may be provided in front of the poster or sign to protect it from the elements.

Although it is preferable for the display carrier to be mounted within the mount it is additionally envisaged that the display carrier may be mounted externally to the mount. In this arrangement, the display carrier both provides one or more display surfaces and acts as the external weather protecting enclosure for the display unit.

The display carrier may be located substantially vertically below the mount, when located in said second position.

The display carrier is preferably lowerable substantially vertically from the mount from the first position to the second position.

The display unit is preferably provided with a locking mechanism for locking the display carrier in said first position. The locking mechanism is preferably located in a base portion of the display carrier for ease of access.

In a preferred embodiment the at least one display surface is visible through an aperture in the display unit, when located in said first position.

Preferably, the display carrier and the mount are oriented substantially concentrically.

For ease of operation, there is preferably at least one guide member to guide the display carrier when it is moved between said first and second positions. Preferably, the at least one guide member ensures that the display carrier is constrained to move along a determined path and that, for example, it is not adversely affected by wind loads in a lowered position. The at least one guide member is preferably slidably mounted in a guide channel. Most preferably, two guide members are provided.

In a preferred embodiment, the display carrier is constrained to move coaxially with regard to the display unit.

Preferably, the display carrier is suspended from the mount by at least one support element.

Irrespective of the particular arrangement utilised to couple the display carrier to the mount, the display carrier is preferably biased, in use, towards said first position. The weight of the display carrier may alternatively be counter-balanced. These arrangements advantageously allow the movement of the display carrier more readily to be controlled and may slow the rate at which the display carrier moves from the first position to the second position. Thus, the display unit may be safer to operate. A separate mechanism may be provided to generate the force required to bias the display carrier towards the first position, or at least partially to counter-balance its weight. The mechanism may, for example, be spring-loaded or pneumatic. Preferably, however, the support elements for supporting the display carrier are adapted to generate the required force, for example by utilising a spring-loaded mechanism.

Conveniently, the self-retracting supports may be attached along the upper edge of the display carrier.

The at least one self-retracting support is preferably a wire.

The display unit may be oval or elliptical in transverse cross-section. This may advantageously reduce wind loading on the lamppost after the display unit has been installed.

Preferably, said display surface is sized to receive a 4 sheet poster (1524 mm×1016 mm).

More preferably, said display surface is sized to receive a 6 sheet poster (1800 mm×1200 mm). It is preferable to use a 6 sheet poster as this is the size generally accepted by the advertising industry.

In a preferred embodiment said display unit is provided with at least one light. Preferably, the at least one light is a backlight. If a display surface is provided behind the poster or sign, it preferably allows light to reach the back surface of the poster or sign to allow the poster or sign to be backlit.

In a further embodiment, the display unit as described herein is fixedly mounted on a lamppost. Although the display unit may be installed on the lamppost prior to installation of the lamppost (or indeed formed integrally with the lamppost), preferably the display unit is installed after the lamppost has been installed. The additional weight of the display unit on the lamppost may make it more difficult to install.

Preferably, the display unit is provided with two display surfaces provided on opposite sides of the lamppost.

In a further embodiment, the lamppost has a transverse hole provided therethrough, said mount comprising a threaded bolt which extends through said transverse hole to mount the display unit.

In the further embodiment, an electrical connection is preferably provided from the lamppost to the display unit for supplying electricity to a light.

It is envisaged that the display unit may be supplied as a kit of parts.

Viewed from a further aspect, the present invention provides a display unit for displaying a poster or a sign, the display unit comprising a display carrier and a mount, the display carrier being movably coupled to the mount and having at least one display surface for displaying the poster or the sign, wherein, in use, the display carrier is locatable in a first position for displaying the poster or sign, and is movable to a second position, lower than the first position, for changing the poster or sign.

The display surface may be provided behind the poster or sign to provide support. Alternatively, the display surface may be at least partially transparent and located in front of the sign or poster. The sign or poster is preferably removably attached to the display surface.

The display unit preferably also has at least one aperture through which the poster or the sign is viewed.

According to a still further aspect of the present invention there is provided a display unit comprising a mount and a display carrier for displaying a poster or a sign, the display carrier being movably coupled to the mount, wherein, in use, the display carrier is locatable in a first position for displaying the poster or sign, and is movable to a second position, lower than the first position, for changing the poster or sign; the display unit further comprising a mechanism for at least partially counter-balancing the weight of the display carrier, or for biasing the display carrier towards said first position.

According to a yet still further aspect of the present invention there is provided means for mounting a display frame on an erected post whereby the post has holes aligned horizontally, which may be integral with the post prior to installation, a threaded rod or pin is inserted through the aligned holes and retained in position, the display frame further comprising sign changing means having a sign or poster carrier assembly attached to drop-down support legs such that the sign or poster carrier assembly can be lowered from the display frame.

This arrangement allows the downward motion of the display carrier to be nore resadily controlled and, thus, improves the safety of the display unit.

According to a still further aspect of the present invention there is provided a means for mounting a display frame on an erected post whereby the post has holes aligned horizontally which may be integral with the post prior to installation, a threaded rod or pin is inserted through the aligned holes and retained in position, preferably there are provided two sets of aligned holes in spaced relation, one above the other with a threaded rod or pin inserted and retained in each set of aligned holes, preferably a circular profile tube which is used as a rain water channel and has holes which align with the horizontally aligned holes in the post, and a top cover moulding are fitted to the post prior to attachment of the other display unit components.

Preferably, there are provided two sets of aligned holes in spaced relation, one above the other with a threaded rod or pin inserted and retained in each set of aligned holes. With the preferred embodiment, a circular profile tube which is used as a rain water channel and has holes which align with the horizontally aligned holes in the post, and a top cover moulding are fitted to the post prior to attachment of the other display unit components.

Preferably, located at the top of the main chassis and mounted on the upper front and rear plates are several spring loaded constant pull retraction devices known to be used for signage support. Although these are located in this position they could also easily be attached inside the drop-down support leg and at the lower position of the sign or poster carrier.

Preferably, each drop-down support leg is connected to one or several of these spring loaded constant pull retraction devices and is therefore always under spring pressure, lifting it to its elevated position.

Preferably, the drop-down support legs are free to slide within a slideway located vertically at both ends of the display unit main chassis. End-stop devices are preferably fitted to prevent the drop-down support legs from coming out of their relative slideways.

Preferably, the sign or poster carrier assembly comprises of two halves which are joined around the post by fixing a pair of lower plates together.

Preferably, the tops of the vertical end sections of the display carrier engage with the plastic slide mouldings located at the lower position of the drop-down support legs.

Preferably, the sign or poster carrier slides up and continues to slide within the channels arranged vertically on the display unit main chassis, the wires from the pull retraction devices specifically arranged to operate in conjunction with the sign or poster carrier are connected and thereby maintain spring pressure to lift the sign or poster carrier to its' elevated position, end-stop devices are fitted to prevent the sign or poster carrier from lowering further than the drop-down support legs will permit, the end-stop devices engage with the plastic mouldings located at the lower position of the drop-down support legs to facilitate this action.

Preferably, the sign or poster carrier comprises two lightweight frames that surround translucent panels for the means of rear illumination, each frame has a channel feature which facilitates the attachment of spring-loaded poster stretching and retaining clips, these clips are fitted with hook features which engage with holes pre-punched in the posters, the design of the spring-loaded poster stretching and retaining clips ensures that spring pressure is applied to the paper or film poster to maintain good even contact with the translucent panels particularly in the preferred curved format and also allows for stretching or contraction of the paper or film media over a period of time.

When securing the street display to a lamp post the main chassis is preferably retained in the required position by simply hooking brackets which are welded to the main cross braces onto the protruding threaded rods or pins aligned in the post. Preferably the display frame main chassis is secured to the threaded rods or pins by additional fasteners. In attaching the display unit main chassis in this way allows for easy access for subsequent fitting of the other parts.

Preferably, once the display unit main chassis is attached to the post, the electrical power supply which provides the means to power the integral lamp units can be connected, the upper front plate assembly, upper support bracket, lower support bracket, lower plate, seal and seal retaining plate can all be fixed in position, the sign changing means can then be fitted.

Preferably, the sign changing means comprises of the sign or poster carrier and drop-down support legs, the drop-down support legs would normally be fitted in position as part of the display unit main chassis assembly, however they could be fitted at the same time as the sign or poster carrier.

Preferably, the front door assembly can be fixed in position followed by fixing the vertical end covers, the top cover moulding can be lowered to completely cover the open top and protect the display unit from the weather.

The present invention will be described with reference to the embodiments illustrated in the accompanying drawings in which:

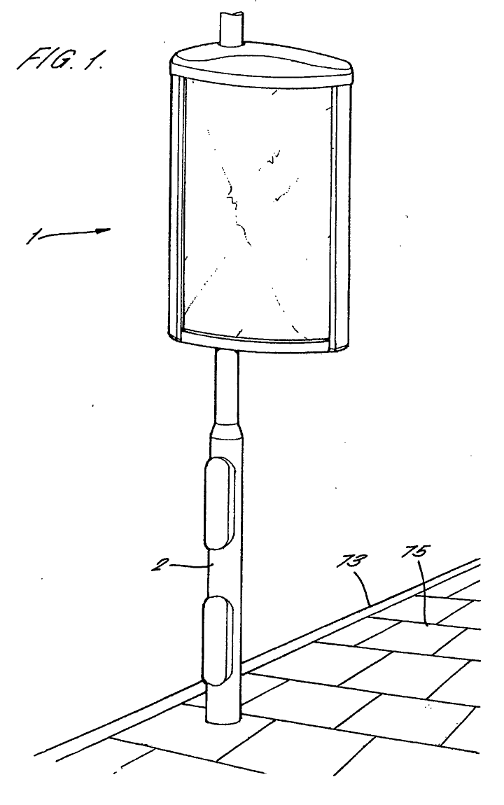

FIG. 1 is a perspective view of a first embodiment of the display unit attached to a lamppost.

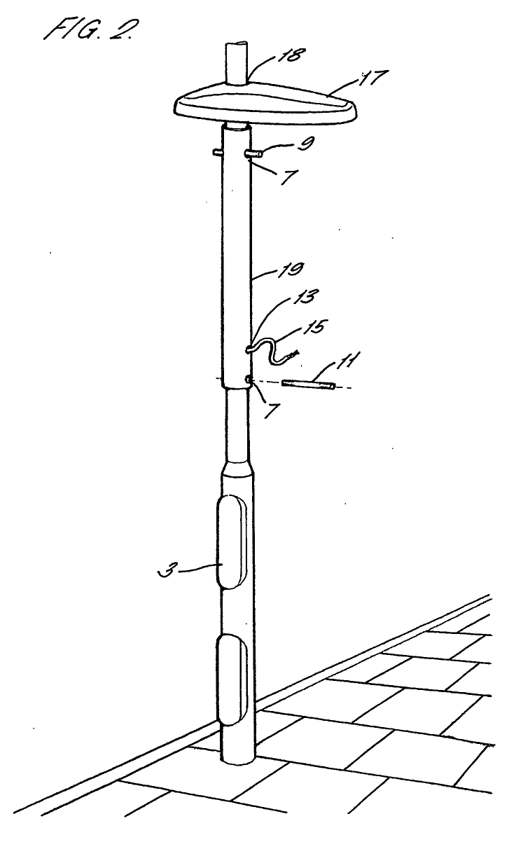

FIG. 2 is a perspective view of a first stage of assembly of the display unit on to the lamppost.

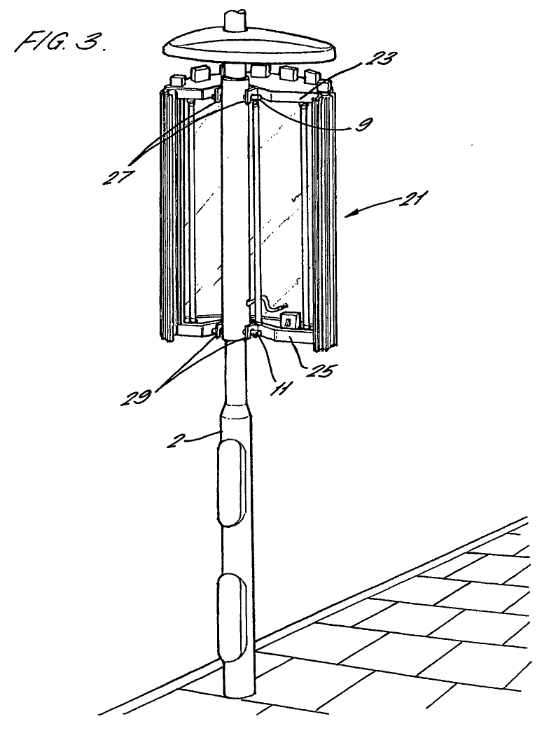

FIG. 3 is a perspective view of a second stage of assembly of the display unit on to the lamppost.

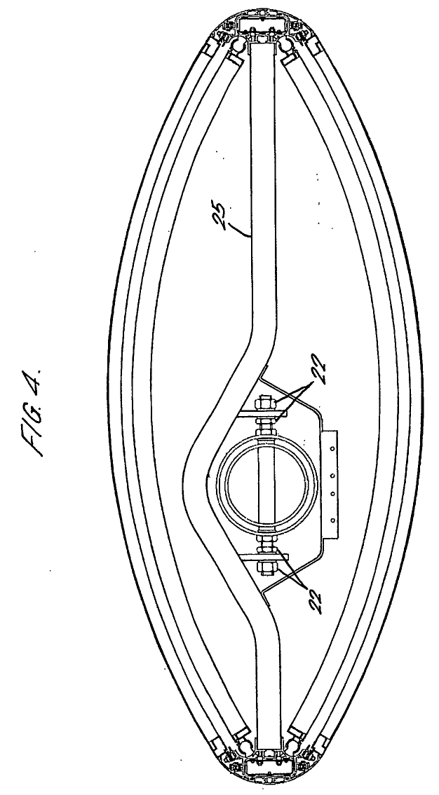

FIG. 4 is a transverse cross-sectional view of the display unit showing the lower cross brace.

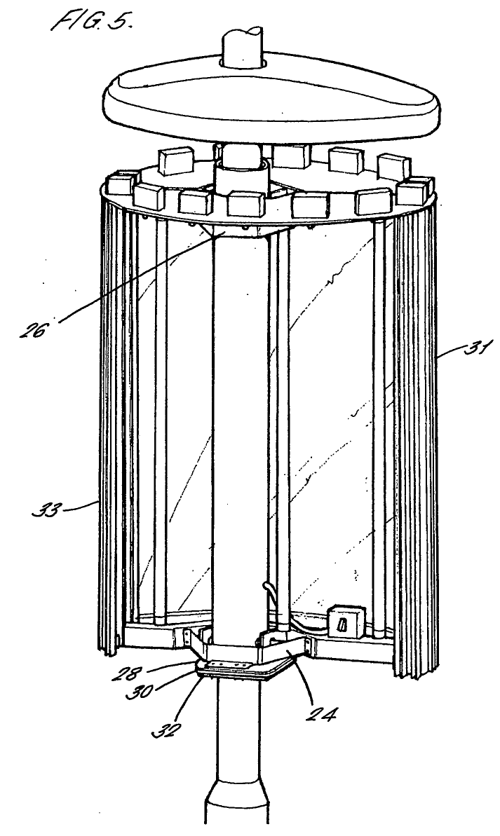

FIG. 5 is a perspective view of a third stage of assembly of the display unit onto the lamppost.

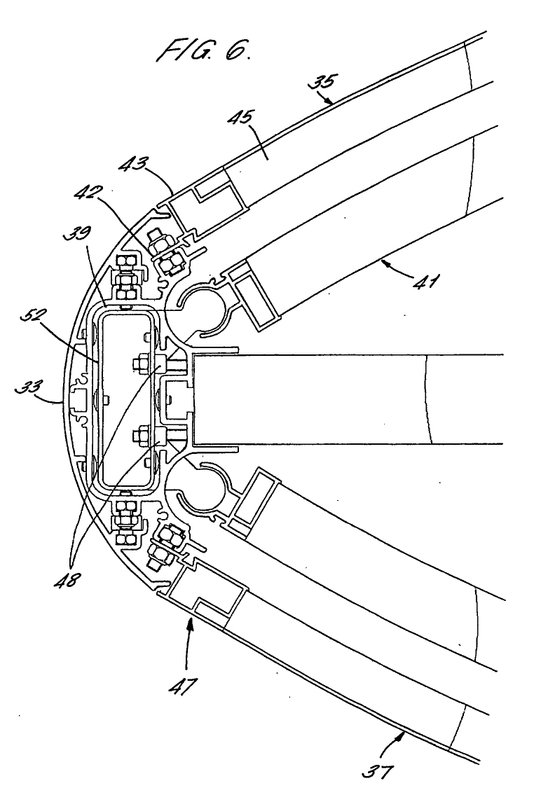

FIG. 6 is a detail transverse cross-sectional view of one side of the display unit.

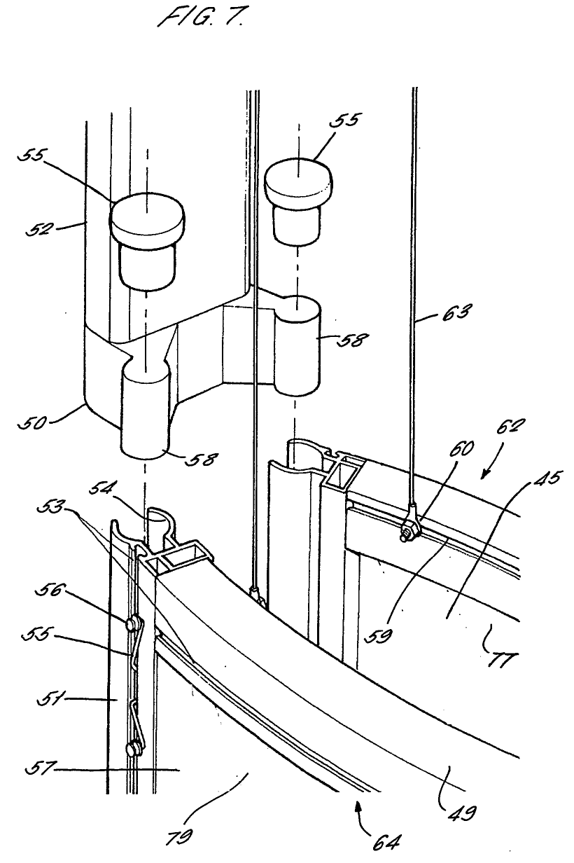

FIG. 7 is a detail perspective view of the display frames and drop-down support leg.

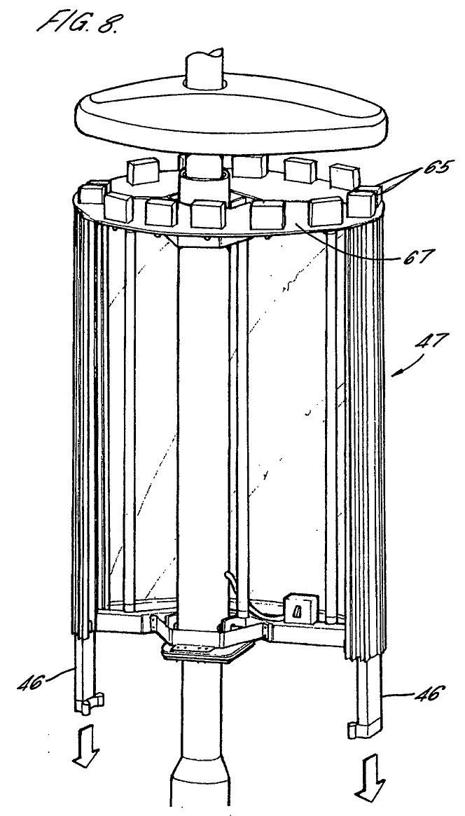

FIG. 8 is a perspective view of a fourth stage of assembly of the display unit onto the lamppost.

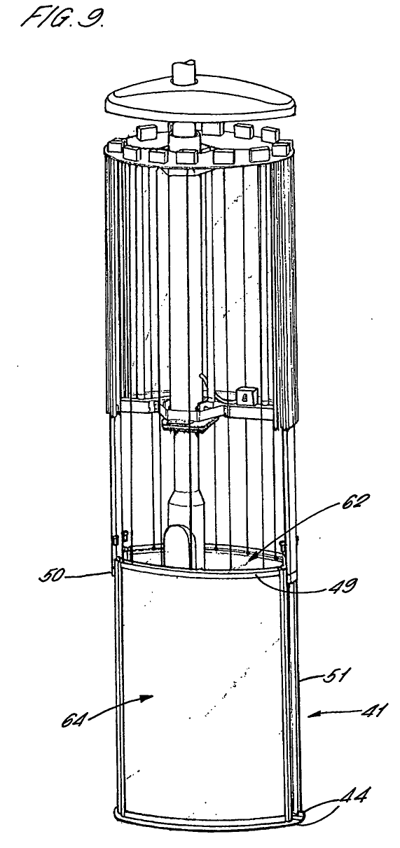

FIG. 9 is a part sectional perspective view of the display unit with lowered display carrier.

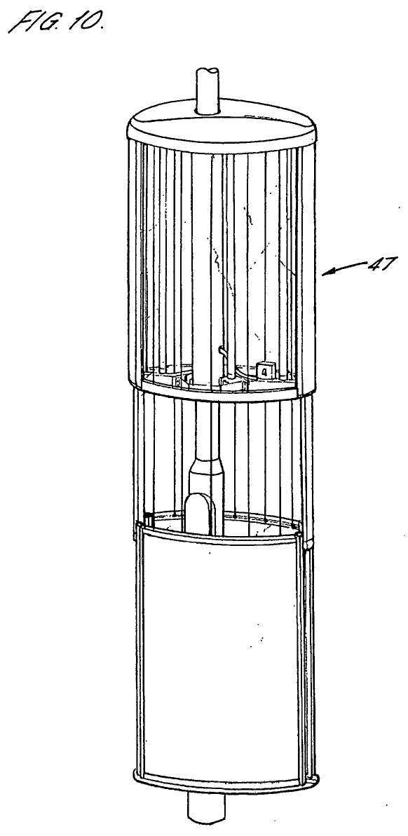

FIG. 10 is a perspective view of the fully assembled display unit with display carrier lowered.

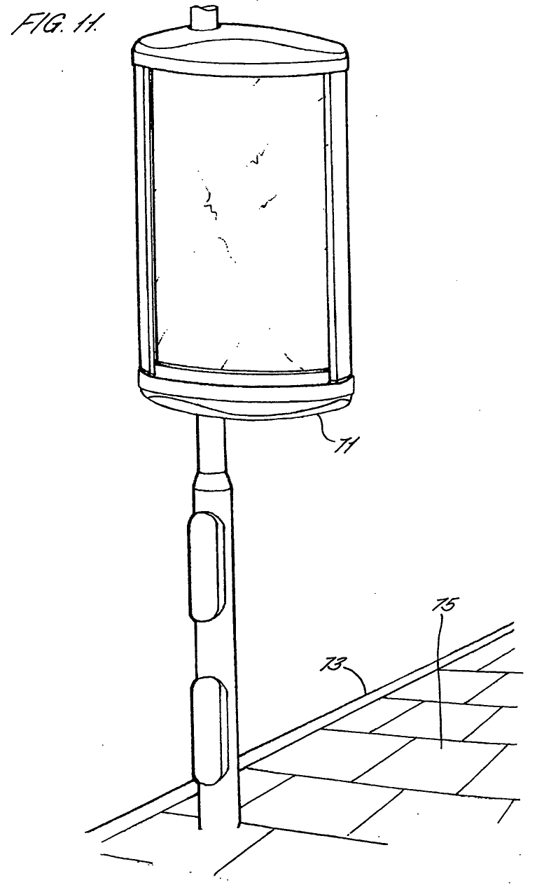

FIG. 11 is a perspective view of a second embodiment of the present invention, showing the display carrier with a bottom cover.

The display unit is constructed so that if desired it can be positioned over a lamppost. To achieve this the display unit has a generally hollow construction and is provided with apertures through which the lamppost may pass. The display unit comprises three principal components, a fixed main chassis, which forms the outer part of the display unit, a movable sign or poster carrier located inside the main chassis and a pair of drop-down support legs which facilitate lowering of the sign or poster carrier from the main chassis. The display unit may display any appropriate sign or poster media, most typically paper, plastic or encapsulated posters. In the preferred embodiment the main chassis has a generally oval or aerofoil cross-section. This acts to reduce the wind loading experienced by the display unit and to improve the visibility of the signs or posters through the transparent curved display surfaces.

FIG. 1 shows the display unit 1 fitted to an adapted lamppost 2. As further shown by FIG. 2, the lamppost 2 has a separate electrical connection box 3 for the electrical supply to the display unit 1, and has two transverse bores 7 through which upper and lower threaded rods 9, 11 are passed and on which the display unit 1 is supported. In addition, a third bore 13 is provided in the lamppost 2 through which an electrical cable 15 is passed for connection to the display unit 1. It is envisaged that the lamppost 2 may be configured in any other suitable manner in accordance with the present invention.

Located over the lamppost 2 is a top cover 17. The top cover 17 is intended to provide weather protection for the display unit 1. It consists of a plastic moulding provided with an aperture 18 through which the lamppost 2 passes. For ease of fitting the diameter of the aperture 18 is made larger than the diameter of the lamppost 2. As a consequence, rainwater may pass through the aperture 18. Therefore, attached below the top cover 17, is a rain water channel 19. The rain water channel 19 is a circular tube having a cross section slightly larger than that of the lamppost 2 and a length slightly less than the height of the display unit 1. The rain water channel 19 is fixed in position by the threaded rods 9,11. The rain water channel 19 acts to protect the internal surfaces of the display unit 1 from any water running down the surface of the lamppost 2.

Attached beneath the top cover 17 is the chassis of the display unit 1 as shown generally at 21 in FIG. 3. At the top and bottom of the chassis 21 are an upper cross brace 23 and a lower cross brace 25, located generally parallel to each other and perpendicularly to the lamppost 2, and which may be fabricated in any suitable manner from, for example, tubular or square section steel. Attached to the cross braces 23, 25 are pairs of upper and lower brackets 27 and 29. It is these brackets 27, 29 which, when hooked over the threaded pins 9,11, support the chassis 21. To secure the chassis 21 to the threaded pins 9,11 suitable fasteners, for example locking nuts 22 as shown in FIG. 4, are located on the threaded pins 9, 11 and tightened against these brackets 27, 29.

Also attached to the lower and upper cross braces 23, 25 are lower support brackets 24 and an upper support bracket 26, as shown in FIG. 5. Attached beneath the lower support bracket 24 is a lower plate 28, and beneath that a seal 30 and a sealing plate 32. The seal 30 and sealing plate 32 create a seal with the bottom of the rainwater channel 19 to prevent water entering the display unit from the rainwater channel. The upper support bracket 26 suppports the upper fixing plate 67. The upper support plate 67 is attached to the upper support bracket using any suitable means.

Attached between the upper and lower cross braces 23, 25 at each end thereof and by suitable attachment means, for example by mechanical fasteners, are vertical end covers 31 and 33 as shown in FIGS. 5 and 6. The end covers 31, 33 are extruded steel sections which provide mounting points for the front door assemblies shown generally at 35, 37 and slideways 39 for the display carrier, shown generally at 41. The front door assemblies 35, 37 comprise extruded frames 43 into which curved transparent panels 45 are fitted as shown in FIG. 6. The front door assemblies 35, 37 are fitted with brackets 42 for mechanical fastening to the vertical end covers 31, 33. When fitted into position the front door assemblies 35, 37 complete the display enclosure 47, as shown in FIG. 10.

Attached to the display enclosure 47 are two drop-down support legs, shown at 46 in FIG. 8, that slidably connect the display carrier 41 to the display enclosure 47. As can be seen from FIG. 6, the support legs 46 comprise elongate hollow steel box sections 52 which slide within slideways 39 provided in the end covers 31,33. At their upper end the support legs 46 are provided with end stop devices 48 which prevent the support legs 46 from disengagement from the slideways 39. At their lower end each support leg 46 is provided with a display frame guide 50 which engages with a channel 54 on each display frame 62, 64, as shown in FIG. 7. To prevent the display frame guide 50 from disengaging with these channels 54 it is provided with an upper region which when in contact with end stops 55, provided in the channel 54, prevents any further downwards movement. The end stop devices 48 and the display frame guide 50 may be attached by any suitable mechanical or adhesive means to the steel box sections 52.

In this first embodiment the frame display frame guide 50 has two guides 58, one for each display frame 62, 64. It is envisaged that for display units having a single display frame only, the display frame guides may have only one guide.

The display carrier 41 is shown in full in FIG. 9. The display carrier 41 comprises two display frames 62, 64 attached together at their lower surfaces by a pair of fixing plates 44 which are provided with apertures to enable the lamppost 2 to pass through them. The display frames 62, 64 are constrained at their upper surfaces by engagement with the display carrier guide 50. The display carrier 41 is sized to fit within the enclosure 47 formed around the chassis 21, see FIG. 10, and is aligned such that the display surfaces 77, 79 provided on the display frames 62, 64 can be viewed through the front door assemblies 35, 37.

As shown in FIGS. 7 and 9, each display frame 62, 64 is generally rectangular and comprises curved upper and lower sections 49 and substantially straight side sections 51. These sections may be attached to each other using suitable mechanical or adhesive fastening means. The channels 54 provided on the side sections 51 have an internal profile corresponding with the external profile of the display frame guide 50. In this embodiment the channels 54 and the guides 58 have a circular profile, although it is envisaged that any other suitable profile may be used.

As shown in FIG. 7, on their outwardly facing surfaces the upper and lower sections 49 and the side sections 51 have channels 53 into which spring-loaded poster stretching and retaining clips 55 are located. Hooks 56 are provided on these clips 55 for engagement with a sign or poster. Fitted within each display frame 62, 64 is a translucent panel 57 to enable a poster, not shown, to be back-illuminated by a lamp, not shown, located on the chassis 21. On their inwardly facing surfaces the upper sections 49 are provided with a channel 59 into which wire connectors 60 may be located for attachment of pull retraction wires 63 connected to spring retractors, as shown at 65 in FIG. 8. It is envisaged that retraction wires may be located elsewhere, for example, they may be located in similar channels provided on the lower curved sections 49.

Spring retractors 65 are located on an upper fixing plate 67 which is in turn attached to the upper cross brace 23 and end sections 31, 33. The upper fixing plate is assembled from two halves, each half having a cut out to enable the lamppost 2 to pass through it. Although it is possible to retract the display carrier 41 using a single spring retractor 65, to ensure that the display carrier 41 is raised smoothly such that the guides 58 do not become jammed in the channels 54, it is advantageous to provide a number of retraction devices 65 along each of the display frames 62, 64.

The sign or poster carrier is free to slide within the slideways and the pull retraction devices will always ensure that it is retracted to its elevated position, however with careful tuning of the spring pressures that are applied a state of near equilibrium can be achieved and therefore minimal assistance will be required in raising or lowering of the sign or poster carrier. A counterweight could be used to hold the sign or poster carrier in its fully lowered position, particularly in strong wind conditions. When the sign or poster carrier is fully retracted it can be locked in position by accessing the lock or locks located in the lower plates.

In the embodiment shown in FIG. 9, the fixing plates 44 are generally flat. However, it is envisaged that the fixing plates 44 may be provided with a bottom cover 71, substantially the same as the top cover 17, as shown in FIG. 11. The provision of a bottom cover 71 protects any users from contact with the angular edges of the display unit 1.

The height at which the display unit 1 is attached to a lamppost is determined by the positioning of the transverse bores 7. The minimum height will normally be limited by local authority regulations, in the UK the lower limit is currently 2.4m. In the present invention the display unit 1 is located at a distance of 3m from ground level. This is to provide protection against vandalism in addition to improving the visibility of the sign.

For pavement mounted signs, to ensure the greatest visibility to both pedestrian and vehicular traffic it is preferred that the street display units 1 are mounted such that the display surfaces are oriented generally perpendicular to the kerb 73. The imposition by local authorities of regulations that restrict the placement of lampposts on a pavement 75 and the distances of display units from a highway means that it is often necessary to offset the positioning of the display unit 1 on the lamppost 2. In the embodiment shown in FIG. 1 the display unit 1 is shown mounted such that the shortest overhang of the display unit 1 is on the kerb side, thereby ensuring that it does not obstruct traffic flow. In locations where there are no such restrictions, for example in car parks, the display unit 1 may be mounted centrally on the lamppost 2.

It is also envisaged that a display unit may be mounted on any other appropriate form of pre-existing vertical support structure, for example, a telegraph pole. Alternatively, a display unit may be mounted to a specially provided vertical support structure, for example to a post which may be moved to a location as desired.

A disadvantage of prior art display signs is that their construction, primarily from metal parts, makes them heavy and consequently difficult to mount in an elevated position. To overcome this the display unit 1 of the present invention may be mounted on the lamppost 2 in a number of assembly stages, as shown by FIGS. 2, 3, 5, 8 and 10.

The display unit 1 according to the embodiment described by FIGS. 1-10 is manufactured largely from metal components which may be for example pressed steel panels or extruded aluminium sections. However, in a further embodiment, for example as shown by FIG. 11, the display unit may be largely manufactured from plastic materials in order to further increase the ease with which the display unit may be fitted.

A method of operation of the display unit 1 will now be described with reference to the FIGS. 1-11.

The display unit 1 of the present invention permits posters or signs to be changed from ground level and hence dispenses with the need for ladders or automated elevation means. To change a poster an operative is supplied with a pole which has both a hook and a key. To enable the display carrier 41 to be lowered a locking means, not shown, must first be disengaged. This is achieved by locating the key end into the lock and rotating it. Any suitable locking means may be employed although generally the locking means should be disengaged by rotation through a quarter turn.

Once unlocked the display carrier 41 is retained in an elevated position by the upwards force applied by the spring retention means 65. Therefore, to draw the display carrier 41 downwards, the operative must engage the hooked end of the pole with a hook, not shown, provided on the base of the display carrier 41. Downwards movement the pole will result in lowering of the display carrier 41. Once the display carrier 41 has been lowered to a level at which the poster may be changed the pole may be released from the hook. The counterbalanced action of the spring retraction means 65 will ensure that the display carrier 41 remains in this position.

The poster or sign may then be changed in a known manner by disengaging the poster stretching and retaining clips 55, replacing the poster and engaging the poster stretching and retaining clips 55. For display carriers 41 supporting two signs or posters this is repeated for the second sign or poster.

The display carrier 41 may then be raised by engaging the hooked end of the pole with the hook on the display carrier 41 and moving the pole upwards. Once the display carrier 41 is in a fully elevated position it may be secured by operating the locking means. This is achieved by engaging the keyed end of the pole with the locking means and rotating it by, typically, a quarter turn.

In addition to arrangements of the display unit in which the display unit is lowered substantially vertically by suspensory means, typically by wires attached to spring loaded retraction devices, it may also be lowered by any other means which are able to both support the display carrier and to extend and retract as required. Such means may include for example, pneumatic or hydraulic struts, or electrically motor driven recoil devices.

In addition to the embodiments described above it is envisaged that the display carrier may be lowerable from the display unit in a number of additional ways without departing from the nature of the present invention. For example, it is envisaged that the display carrier may be lowered from an elevated position using a mechanical linkage. This linkage may utilise extending slideways, for example as used in the embodiment of the display unit described above, or may use an extending mechanical linkage.

The display carrier may be attached to the mount in a hinged manner such that the display carrier may be lowered from an elevated position by following a rotational rather than a linear path. The display carrier may have a hinge along for example its bottom edge and may be provided with a torsion bar or similar to facilitate lowering of the spring carrier. It is envisaged that the display carrier may rotate about an axis either parallel or perpendicular to the display surfaces.

1-31. (canceled)

32. A display unit (1) for mounting on a post (2), the display unit comprising a mount (21) mountable on the post, a top cover (17) and a display carrier (41) for displaying a poster or a sign, the display carrier being movably coupled to the mount; wherein, in use, the display carrier is locatable in a first position for displaying the poster or sign, the display carrier being movably coupled to the mount; and is movable to a second position, lower than the first position, for changing the poster or sign; characterized in that the display unit further comprises a rainwater channel (19) for mounting around the post, the rainwater channel, in use, protecting the internal surfaces of the display unit from any water running down the surface of the post.

33. A display unit (1) as claimed in claim 32, wherein said second position is at or proximal to ground level.

34. A display unit (1) as claimed in claim 32, wherein the display carrier (41) is suspended from the mount.

35. A display unit (1) as claimed in claim 32, wherein the display carrier (41) is suspended substantially within the mount (21), when located in said first position.

36. A display unit (1) as claimed in claim 32, wherein the display carrier (41) is located substantially vertically below the mount, when located in said second position.

37. A display unit (1) as claimed in claim 32, wherein the display carrier (41) is lowerable substantially vertically from the mount from the first position to the second position.

38. A display unit (1) as claimed in claim 32, wherein the display carrier (41) comprises at least one display surface (77, 79) and said at least one display surface is visible through an aperture in the display unit (21), when located in said first position.

39. A display unit (1) as claimed in claim 32, wherein the display carrier (41) and the mount (21) are oriented substantially concentrically.

40. A display unit (1) as claimed in claim 32, further comprising at least one guide member (50) to guide the display carrier (41).

41. A display unit (1) as claimed in claim 32, wherein the display carrier (41) is constrained to move coaxially with regard to the display unit.

42. A display unit (1) as claimed in claim 32, wherein the display carrier (41) is suspended from the mount by at least one support element (63).

43. A display unit (1) as claimed in claim 42 in which each support element (63) is attached along the upper edge of the display carrier.

44. A display unit (1) as claimed in claim 42, wherein each support element (63) is a wire.

45. A display unit (1) as claimed in claim 42, wherein the at least one support element (63) biases the display carrier (41), in use, towards said first position.

46. A display unit (1) as claimed in claim 42, wherein each support element (63) is self-retracting.

47. A display unit (1) as claimed in claim 32, further comprising a biasing mechanism (65) for biasing the display carrier (41) towards said first position.

48. A display unit (1) as claimed in claim 32, further comprising a counter-balance mechanism for at least partially counter-balancing the weight of the display carrier (41).

49. A display unit (1) as claimed in claim 32, which is oval or elliptical in transverse cross-section.

50. A display unit (1) as claimed in claim 32, further comprising a display surface (77, 79), wherein said display surface is sized to receive a 4 sheet poster.

51. A display unit (1) as claimed in claim 32, further comprising a display surface (77, 79), wherein said display surface is sized to receive a 6 sheet poster.

52. A display unit (1) as claimed in claim 32, provided with at least one light.

53. A display unit (1) as claimed in claim 52, wherein the at least one light is a backlight.

54. A display unit (1) comprising a mount (21), a top cover (17) and a display carrier (41) for displaying a poster or a sign, the display carrier being movably coupled to the mount, wherein, in use, the display carrier is locatable in a first position for displaying the poster or sign, and is movable to a second position, lower than the first position, for changing the poster or sign; characterized in that the display unit comprises a mechanism (65) for at least partially counter-balancing the weight of the display carrier, or for biasing the display carrier towards said first position; the display unit further comprising a rainwater channel (19) for mounting around the post, the rainwater channel, in use, protecting the internal surfaces of the display unit from any water running down the surface of the post.

55. A display unit (1) as claimed in claim 54, in combination with a lamppost (2), wherein the display unit is fixedly mounted on the lamppost.

56. A display unit (1) as claimed in claim 55, wherein the display unit is provided with two display surfaces (77, 79) provided on opposite sides of the lamppost (2).

57. A display unit (1) as claimed in claim 55, wherein the lamppost (2) has a transverse hole provided therethrough, said mount (21) comprising a threaded bolt which extends through said transverse hole to mount the display unit.

58. A display unit (1) as claimed in claim 55, wherein an electrical connection is provided from the lamppost (2) to the display unit for supplying electricity to a light.

59. A kit of parts for assembling a display unit (1) as claimed in claim 54.

60. A display frame (1) mounted on an erected post (2) whereby the post has holes (7) aligned horizontally and a threaded rod or pin (9, 11) is inserted through the aligned holes and retained in position, the display frame further comprising sign changing means having a sign or poster carrier assembly (41) attached to a drop-down support legs (46) such that the sign or poster carrier assembly can be lowered from the display frame; characterized in that the apparatus further comprises a circular profile tube which is used as a rainwater channel (19) and
